(19) United States
(12) Patent Application Publication
(10) Pub. No.: US 2006/0249091 A1
(43) Pub. Date: Nov. 9, 2006

(54) Portable screening device

(76) Inventor: David M. Orbach, Livingston, NJ (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/416,030

(22) Filed: May 2, 2006

Related U.S. Application Data
(60) Provisional application No. 60/678,876, filed on May 6, 2005.

(51) Int. Cl. A01K 29/00

(52) U.S. Cl. 119/169

(57) ABSTRACT

A screening device has elongate sheet of a thin non-transparent material windably mounted at one end to a spring-activated rotatable rod within a portable housing having a longitudinal slot through which the sheet is movable for winding and unwinding purposes while being prevented from passing entirely into said container through said slot. The container is provided at one end thereof with means for readily and releasably connecting the same in an upright position with a stationary object, while a supporting post is connectible to said sheet at the free end thereof and adapted to be secured to a stationary object at a distance from said first mentioned stationary object to thus support the unwound sheet in a substantially vertical position.

### BACKGROUND OF THE INVENTION

This invention relates to means for enhancing road traffic safety by preventing accidents, delays and other complications frequently caused by curiosity and unwarranted activities on the part of travelers on a roadway passing the scene of a previous accident that is under clean-up and investigation by rescue and law enforcement personnel.

Under present-day traffic conditions on express roads and highways, particularly in inclement weather, it is a common occurrence that a more or less serious accident becomes the cause of traffic jams and/or additional accidents due to the fact that other travelers slow down or even stop in the vicinity of the original accident scene in order to view the scene or, perhaps, in some cases to bring assistance to victims. This is the case both on the side of the road where the accident occurred and on the side of the road opposite to where the accident occurred. Such behavior frequently continues even after the arrival of emergency vehicles, such as police or patrol cars, towing cars, fire trucks, ambulances or the like, in spite of the fact that the rescue work would be greatly facilitated if the road traffic proceeded as unhampered as possible.

Several devices have tried to provide solutions to this problem, each with limited success. For example, U.S. Pat. No. 193,573 to Tripp disclosed an improvement in movable partitions or screens consisting of a flexible screen that when not in use is up on a spring-loaded portable cylindrical roll. When in use, the screen may be unwound, extended and mounted to walls or to heavy-based, movable posts.

U.S. Pat. No. 4,124,196 to Hipskind disclosed a portable screening device having a non-transparent elongate sheet that is perforated to relieve wind pressure and is secured at one end to a spring-activated rod on which the sheet is windable, the rod being mounted within a portable cylindrical container having a longitudinal slot through which the sheet is movable for winding/unwinding while being prevented from passing entirely into said container through said slot. The container is intended to be mounted in an upright position to a bracket that is clamped to a stationary object, such as a car bumper, and the free end of the sheet can be extended and secured to a stationary object using ropes or a supporting post.

U.S. Pat. No. 6,733,204 to Paniccia disclosed a view shield device having a flexible screen that is spring wound within a cylindrical housing and exits therefrom via an elongated slot when pulled by a handle at the free end of the screen. Each shield can be removably mounted into one of a plurality of wells in a mounting block such that the shields extend upward, and one screen may be attached to another via hooks at the free end of the screen that attach to another housing, such that the screen of a first shield may be extended between and attached to a second shield so that a passing motorist may not see between the first and second shield housings.

Unfortunately, none of these devices is truly portable because they require the use of heavy bases or mounting blocks to secure the screen housings. In addition, these devices require specialized equipment or installation, such as special brackets or mounting posts, and they cannot be used effectively if these items are not present. Furthermore, these shield devices allow a viewer to see between the screens of adjacent devices and do not completely block viewers from seeing what is intended to be shielded from view. Moreover, none of these devices allows the user to increase the view shield area vertically to provide enhanced screening above the level of the adjacent screens, for example where the area to be screened is lower than the view area or can be viewed by motorists with a higher vantage point.

### OBJECTS OF THE INVENTION

One object of the present invention is to provide means whereby a roadside accident scene may be rapidly and effectively shielded from the view of passing motorists.

Another object of the invention is to provide a screen and supporting equipment that can be conveniently carried by an emergency vehicle and readily erected in position to prevent travelers from viewing the accident scene and any associated rescue and clean-up activities.

A further object of the invention is to provide a screen for the purpose indicated, which is preferably made of a thin, light-weight material and is adapted to be carried by emergency vehicles in a compact condition.

Yet another object of the invention is to provide a portable screen that is subject to reduced wind pressure on the screen in its erected condition.

A still further object of the invention is to provide lightweight, yet sturdy, means for supporting the screen in proper position at the accident scene.

Another object of the invention is to provide a screening arrangement in which two or more screens of the type indicated above may be mounted one on top of another to thereby increase the total height of the screening device.

A further object of the invention is to provide a screening arrangement in which two or more screens can be attached one alongside another to thereby increase the total length of the screening device.

### BRIEF DESCRIPTION OF THE DRAWINGS

Additional objects and features of the invention will be apparent from the following detailed description taken in conjunction with the accompanying drawings, in which

FIG. 1 is an overhead view of an accident site at the edge of a three-lane expressway,

FIG. 2 is a side view of the screening device according to the invention,

FIG. 3 is a perspective view of attaching means affixed to the outside of the cylindrical container for attaching the cylindrical container to an adjacent screen, and

FIG. 4 is a perspective view of attaching means affixed to the free end of the screen for attaching the screen to an adjacent cylindrical container,

FIG. 5 shows, in side elevation, an erected screening device with a second and a third similar screen mounted on top thereof, and

FIG. 6 is a perspective view of the base for supporting the screening device.

### DETAILED DESCRIPTION OF THE INVENTION

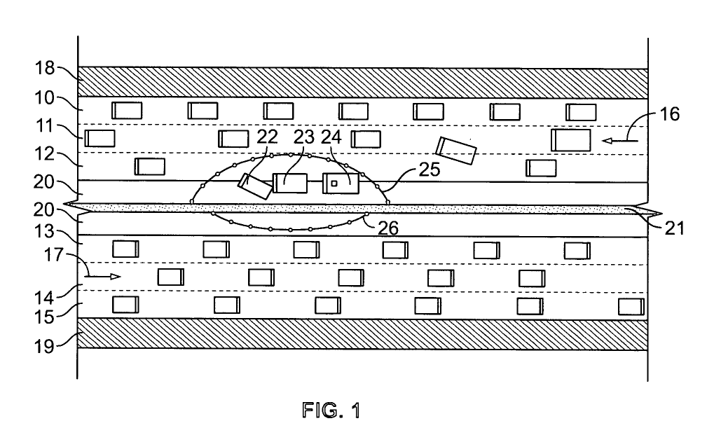

FIG. 1 shows a section of an expressway with three traffic lanes 10, 11, 12 in one direction and three traffic lanes 13, 14, 15 in the opposite direction, as indicated by arrows 16 and 17, respectively. Outside of lane 10 there is one shoulder 18 and outside of lane 15 is another shoulder 19, while the space between lanes 12 and 13 is occupied by dividing region 20, such as a double shoulder that could also be divided longitudinally by a barrier 21.

FIG. 1 depicts the scene of an accident wherein an automobile 22 traveling in lane 12 was hit from behind by another automobile 23, causing both vehicles to be partially thrown out of lane 12 onto the shoulder 20, both vehicles in this example shown remaining in upright position. One or more occupants of the vehicles may have sustained injuries and, perhaps, have been thrown to the ground. Even if the two vehicles 22, 23 directly involved in the accident have come to a halt entirely on the shoulder 20, the drivers of vehicles following the second automobile in lanes 12, 11 and 10 will in most cases stop or at least slow down in order to bring help or just plainly to “gawk” at the scene, and in the present case the vehicles in lane 12 will eventually attempt to move to lane 11. In any case, a serious traffic jam will typically occur, usually with vehicles accumulating in long lines behind the accident site. Similar traffic congestion usually occurs also in one or more of lanes 13, 14, 15 for assistance and/or curiosity (“rubber-necking”) reasons.

The first emergency vehicle 24 to arrive at the scene will generally park behind the second automobile 23 with its warning lights flashing. In accordance with the present invention, the occupants of emergency vehicle 24—policemen, firemen, or state troopers, etc.—will proceed to erect a screening device as described herein, which is preferably routinely carried in the emergency vehicle. As more such vehicles arrive, an embodiment of the continuous screen 25 is rapidly erected and expanded in lane 12 and subsequently on the opposite side of the accident site on the shoulder 20, as at 26, to effectively screen off the accident site from view in all directions and thus prevent traffic jams caused by curious “gawkers”.

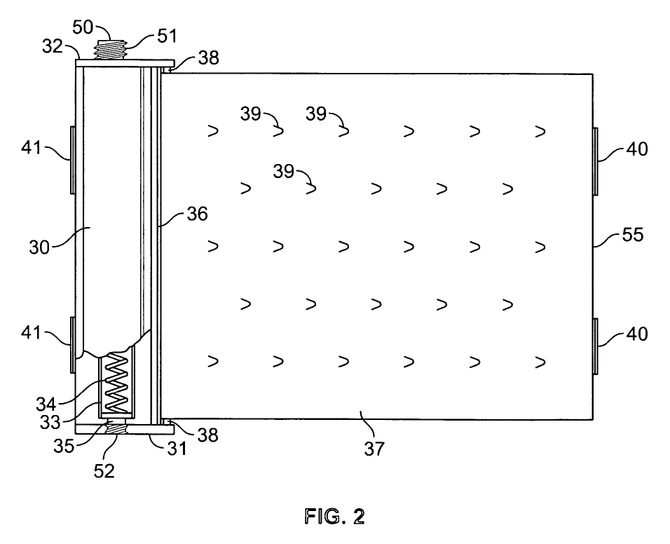

The design and construction of the inventive screen will now be described in detail with reference to the drawings. As shown in FIG. 2, the screening equipment carried in the emergency vehicle includes a housing or container 30, which is preferably cylindrical and provided with closure plates 31, 32 at both ends. Extending centrally through said container 30 is a tube 33 which is rotatably connected with the closure plates 31, 32 in the same manner as an ordinary curtain rod of the kind containing a coil spring 34. One end of the spring 34 is secured to a member 35 which is rotatably connected with the tube 33 and non-rotatably mounted in the plate 31, while the other end of the spring 34 is secured to the tube 33 at the opposite end thereof.

The container 30 is provided with a longitudinal slot 36 that extends preferably from one end of container 30 to the other end of container 30. A sheet 37 of a flexible material to be described below retractably extends through slot 36. One end of said sheet 37 is secured to the spring-loaded tube 33 in the manner of a shade or curtain to a curtain rod. The opposite end of the sheet 37 is provided with attaching means 40, as described below, that prevents passage of sheet 37 through the slot 36 into the container 30.

A rod 38 may be secured to container 30 alongside the slot 36 to prevent frictional damage to the sheet by the edges of the slot 36, as it is moved therethrough. Rod 38 may have a round or any other cross-sectional shape, provided that it has a smooth surface in order to minimize friction on sheet 37 as it is unrolled from and rolled into the container 30 through the slot 36. Rod 38 is preferably affixed at its ends to the plates 31, 32 and is preferably set in a position relative to slot 36 such that it minimizes the contact between sheet 37 and the edges of slot 36.

The sheet 37 is preferably a thin, lightweight material that is strong, durable and preferably weather-resistant, such as a cloth-backed vinyl or similar material. The sheet 37 is preferably provided with apertures or perforations 39 of a size and spacing to relieve wind pressure on the sheet, when in extended position of use, as described below. In a preferred embodiment, the apertures 39 are not completely cut through but rather remain partially attached to the sheet 37 on one side of the perforation. For example, one embodiment, the apertures 39 have a triangular shape, as shown in FIG. 2, with the material of each triangular perforation being attached to sheet 37 at one base side thereof rather than being completely cut-out. Apertures 39 should be sufficiently small to prevent easy viewing therethrough, particularly from a moving vehicle, but to allow passage of wind therethrough.

The sheet 37 may be made any thickness, height and length as desired. A preferred thickness of the sheet, or screen, 37 is approximately 0.5 cm or less, and a preferred height is approximately 4-5 feet. The length of sheet 37 may vary considerably as, for example, from about 10 to about 50 feet.

At the free end of the sheet 37 is an attaching means 40, as described below, for selectively attaching a first sheet 37 to another container 30, as described below. When arranged for storage or to be carried by an emergency vehicle, the screen 37 is preferably retracted, in the manner of a rolled-up window shade, so that it is tightly wound around the tube 33 in the container 30 with the spring 34 under minimal tension. However, because the width of attaching means 40 is larger than the width of the opening of slot 36, the attaching means 40 is situated immediately outside the slot 36 when sheet 37 is arranged for storage and provides a handle for pulling sheet 37 out of the container 30. The arrangement of the spring 34 is such as to place the screen 37 under ever increasing tension as the screen 37 is being pulled out of the container 30.

Each emergency vehicle (police or patrol car 24, etc.) carrying one or more container 30 with the screen 37 in rolled-up condition therewithin is preferably provided with means for easy and speedy mounting and retaining of the container 30 thereon in an upright position. In a preferred embodiment, in order to enable the screen to remain upright on the road surface on which it is placed, a base 60 is secured to the bottom of container 30. The base 60 preferably should be composed of a strong and durable material and should be of a sufficient circumference, thickness and weight to provide support for the screening device under adverse weather conditions. The base 60 should also be of dimensions that allow for easy transportation, such as in the trunk of emergency vehicle 24.

As shown in FIG. 6, the base 60 should preferably contain a protrusion 61 with external screw threads about its vertical circumference to allow attachment to the container 30. In order to accommodate the protrusion 61 of the base 60 below it, the bottom closure plate 31 of container 30 has a hole 52 with corresponding internal screw threads around its interior circumference to allow protrusion 61 to be mated therewith for secure attachment. Each protrusion 61 can be attached to a bottom closure plate 31 of container 30 in the same manner as a screw is fastened into a bolt. Alternatively, the bottom closure plate 31 of container 30 may contain the threaded protrusion that is to be mated with a hole formed within base 60 having corresponding internal screw threads. Of course, container 30 and base 60 may have any other suitable mounting connection that allows quick mounting of container 30 onto base 60 and de-mounting therefrom and provides a secure and stable connection while container 30 is mounted on base 60.

As shown in FIG. 1, two or more screens 37 may be attached one to another to provide lengths of view shielding that are greater than one screening device alone will physically allow. The attaching means can be any device that detachably attaches one screen 37 to the container 30 of an adjacent screen, such as hooks, clips, bolts, tabs, detents, interlocking or mating parts, etc. The attaching means should preferably have no external parts that could be misplaced and thereby prevent attachment of one screen to another and should preferably be of a lightweight material, such as a type of metal or hard plastic, that is strong and durable to enable the screen 37 to remain securely attached to the other container 30.

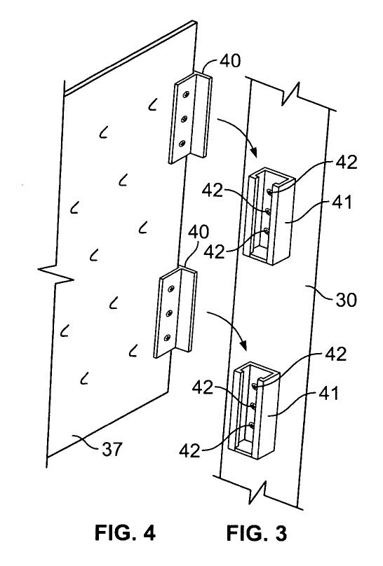

The attaching means can also be a mating structure. For example, as shown in FIGS. 3 and 4, screens 37 are attached via attaching means, generally indicated at 40 and 41. At the free end of the screen 55 is fastened a first mating attaching means 40 which is preferably of a length and thickness to enable the screen 37 to remain securely attached to the corresponding attaching means 41 affixed to another container 30. A second mating attaching means 41, which should also be of a length and thickness to enable the container 30 to remain securely attached to the screen 37, should be fastened to the vertical side portion of each container 30, for example by screws 42 or some similar affixing means, in an upright position.

The screen 37 is pulled out of its container 30 to the desired length. The screen 37 is then lined up with another container 30 such that the emergency personnel is able to slide the attaching means 40 into the corresponding attaching means 41 to mate therewith. In the embodiment shown in FIGS. 3 and 4, wherein attaching means 40 is inserted downward into attaching means 41 to mate therewith, the bottom portion of each attaching means 41 should be closed in order to prevent any detachment. In a preferred embodiment, as in FIGS. 3 and 4, the free end of a first screen 37 is attached flush against the adjacent container 30 to provide no space or a minimum space between them so as to prevent viewers from looking between the screens of adjacent devices and being able to see what is intended to be shielded from view.

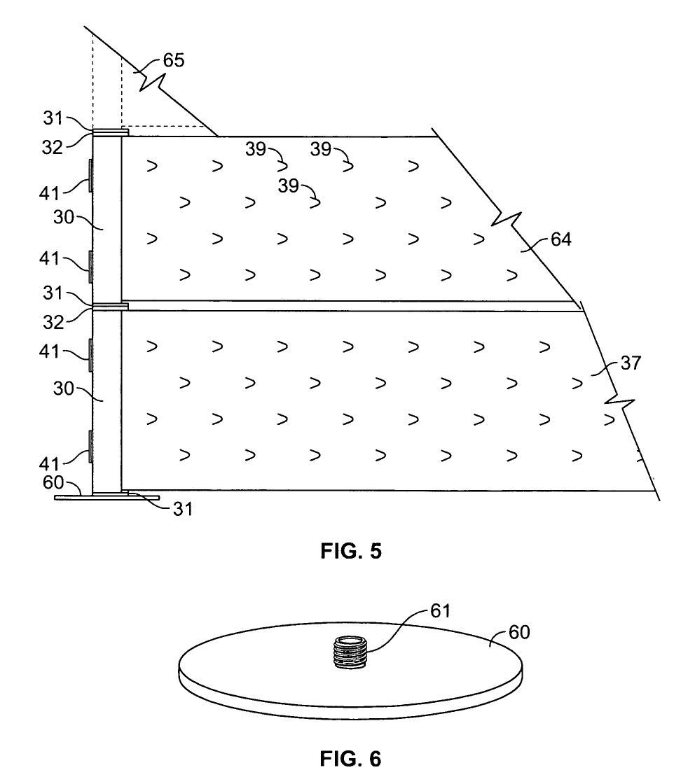

As shown in FIG. 5, two or more screens 37 may be mounted one above another in order to provide greater view shielding in the vertical direction. In order to allow one screen to be mounted above another, each container 30 has a rod, flange or other protrusion 50, secured to and extending upwards from the top side of the upper closure plate 32 of the container 30 that is shaped, as protrusion 61 of base 60, to mate with hole 52 located in the bottom closure plate 31 in order to accommodate the protrusion 50 of a container 30 below it. Alternatively, the bottom closure plate 31 of container 30 may contain the threaded protrusion 50 that is to be mated with a hole 52 that is formed within the upper closure plate 32 of the container 30 below it. The protrusion 50 should have external screw threads 51 around its vertical circumference and the corresponding hole 52 should preferably have corresponding internal screw threads around its interior circumference, as discussed above. Each protrusion 50 of a first container 30 can be secured with hole 52 of another container 30 in the same manner as a bolt is fastened to a screw. Of course, container 30 may have any other suitable mounting connection that allows quick mounting of another container 30 thereon and de-mounting therefrom and provides a secure and stable connection while one container 30 is mounted onto another.

In this manner, protrusion 51 extends above the upper edge of the screen a sufficient distance for connection with a screen container 30 belonging to a second screen above it, to form an extension upwardly of the screen 37, when required. Alternatively, protrusion 51 may extend below the lower edge of the screen a sufficient distance for connection with a screen container 30 belonging to a second screen below it. A third screen may be similarly mounted above said second screen. In most cases one (or two) screen has been found sufficient, since the activities on or close to the ground behind the screen usually are what most interest the “gawkers”. In order to enable the stacked screens to remain upright on the road surface on which it is placed, a base 60, as described above, is secured to the container 30 of the bottom-most screen 37.

Thus, a portable screening device has been provided. One skilled in the art will appreciate that the present invention can be practiced by other than the described embodiments, which are presented for purposes of illustration and not limitation, that the invention is not restricted in any respect by the specific details described and shown, and that numerous modifications and mechanical equivalents are also feasible within the scope of the foregoing descriptions.

What is claimed is:

1. A portable screening device, comprising:
a housing having a top wall, a bottom wall and a peripheral wall extending between said top and bottom walls, said bottom wall comprising a first mounting connection;
an elongated slot extending through said peripheral wall;
an elongated screen retractably positioned within said housing and having a free edge extending through said slot;
a portable base containing a second mounting connection for mating with said first mounting connection when said housing is mounted onto said base, said base being of sufficient weight to provide support for said housing when mounted thereon and when said screen is extended from said housing.

2. The portable screening device of claim 1, wherein said screen comprises a flexible, non-transparent material.

3. The portable screening device of claim 2, wherein said screen further comprises apertures to allow passage of wind therethrough.

4. The portable screening device of claim 1, further comprising an axle about which said screen is wound, said axle being rotatably positioned in said housing and extending between said top and bottom walls, and a biasing means for biasing rotation of said axle in a first direction.

5. The portable screening device of claim 1, further comprising a handle attached to said free edge of said screen for selectively extending and retracting said screen and for selectively attaching said free edge to the housing of an adjacent screening device, and an attachment means attached to said housing,
said handle having a width greater that the width of the opening of said slot in said container peripheral wall so to prevent said free edge of said screen from being retracted into said housing; and
said handle being adapted to mate with the attachment means attached to the housing of an adjacent screening device to allow said free edge of said screen to be extended between and attached the housing of a second screening device.

6. The portable screening device of claim 5, wherein said handle is a male element and said attachment means is a female element, wherein said handle is inserted within said attachment means and prevented by said attachment means from exiting therefrom, so as to secure said free edge of said screen to the housing of a second screening device.

7. The portable screening device of claim 1, wherein said first and second mounting connections comprise mating threaded connections to mount said housing to said base by threadably mating said first mounting connection with said second mounting connection.

8. The portable screening device of claim 1, wherein said housing contains in said top wall a third mounting connection similar to said second mounting connection in said base for mating with said first mounting connection, wherein the housing of a second screening device may be selectively mounted onto the housing of said screening device by mating a first mounting connection of said second screening device with said third mounting connection in the same manner as the housing of said screening device is mounted onto said base.

9. The portable screening device of claim 8, wherein said first and third mounting connections comprise mating threaded connections to mount said second screening device to said housing by threadably mating said first mounting connection of said second screening device with said third mounting connection.

10. The portable screening device of claim 1, wherein said housing and said base may be transported and erected without any other equipment.

11. A portable screening system, comprising:
a plurality of screening devices, each screening device comprising:
a housing having a top wall, a bottom wall and a peripheral wall extending between said top and bottom walls,
an elongated slot extending through said peripheral wall,
an elongated screen retractably positioned within said housing and having a free edge extending through said slot, and
said bottom wall comprising a first mounting connection and said top wall comprising a second mounting connection, said first and second mounting connections being adapted to mate when a second screening device housing is selectively mounted onto a first screening device housing,
at least one portable base containing a third mounting connection for mating with said first mounting connection when a first of said screening devices is mounted onto said base,
said base being of sufficient weight to provide support for a plurality of said housings when mounted thereon and when said screens are extended from said housings.

12. The portable screening system of claim 11, wherein said screen comprises a flexible, non-transparent material.

13. The portable screening system of claim 12, wherein said screen further comprises apertures to allow passage of wind therethrough.

14. The portable screening system of claim 11, further comprising an axle about which said screen is wound, said axle being rotatably positioned in said housing and extending between said top and bottom walls, and a biasing means for biasing rotation of said axle in a first direction.

15. The portable screening system of claim 11, each screening device further comprising a handle attached to said free edge of said screen for selectively extending and retracting said screen and for selectively attaching said free edge to the housing of an adjacent screening device, and an attachment means attached to said housing,
said handle having a width greater that the width of the opening of said slot in said container peripheral wall so to prevent said free edge of said screen from being retracted into said housing; and
said handle being adapted to mate with the attachment means attached to the housing of an adjacent screening device to allow said free edge of said screen to be extended between and attached the housing of a second screening device.

16. The portable screening system of claim 15, wherein said handle is a male element and said attachment means is a female element, wherein said handle is inserted within said attachment means and prevented by said attachment means from exiting therefrom, so as to secure said free edge of said screen to the housing of a second screening device.

17. The portable screening system of claim 11, wherein said first and third mounting connections comprise mating threaded connections to mount said housing to said base by threadably mating said first mounting connection with said third mounting connection.

18. The portable screening system of claim 11, wherein said first and second mounting connections comprise mating threaded connections to mount said second screening device housing to said housing by threadably mating a first mounting connection of said second screening device with said second mounting connection.

19. The portable screening system of claim 11, wherein said plurality screening devices and said at least one base may be transported and erected without any other equipment.
